(19) United States
(12) Patent Application Publication
(10) Pub. No.: US 2011/0149612 A1
(43) Pub. Date: Jun. 23, 2011

(54) Control Method and Controller with constant output current control

(76) Inventor: Wen-Chung Yeh, Hsin-Chu (TW)

(21) Appl. No.: 12/960,560

(22) Filed: Dec. 6, 2010

(30) Foreign Application Priority Data
Dec. 23, 2009 (TW) 098144442

(51) Int. Cl. H02M 3/335

(52) U.S. Cl. 363/21.09

(57) ABSTRACT

Control method and related controller, applicable to a power supply with a switch and an inductive device. The inductive current through the inductive device is sensed. An operating frequency of the switch is controlled to make an average of the inductive current substantially equal to a predetermined portion of the peak of the inductive current and to make the inductive device operated in continuous conduction mode.

### BACKGROUND OF THE INVENTION

1. Field of the Invention

The present invention is related to a switched-mode power supply (SMPS), and more particularly, to an SMPS which provides constant voltage and constant current functions.

2. Description of the Prior Art

A power supply is used as a power management device for converting a power source to be supplied to other electronic devices or components. Certain power converters are required to have both constant voltage and constant current functions. For instance, a battery charger requires both constant voltage and constant current functions. The battery charger shall provide an approximately constant output current for charging a rechargeable battery that is not fully charged; it, nevertheless, shall provide an approximately constant output voltage when a rechargeable battery is fully charged, or when the rechargeable battery is non-existent. In other cases, LED drivers are also required to possess both constant voltage and constant current functions.

U.S. Pat. No. 7,414,865 discloses an SMPS which has constant current functionality. In an embodiment of U.S. Pat. No. 7,414,865, discharge time for a transformer to completely discharge its magnetic energy is detected in a power converter. However, as shown in the cover page of U.S. Pat. No. 7,414,865, when applied to an integrated circuit, the integrated circuit requires one pin to perform the detecting action.

### SUMMARY OF THE INVENTION

The present invention discloses a control method for a power supply with a switch and an inductive device. The control method comprises detecting an inductive current flowing though the inductive device; and controlling an operating frequency of the switch for causing an average of the inductive current to substantially equal a predetermined portion of a peak current of the inductive current, wherein the predetermined portion approximately allows the inductive device to operate in a continuous conduction mode.

The present invention further discloses a controller for a switched-mode power supply (SMPS). The SMPS comprises an inductive device and a switch for energizing or de-energizing the inductive device. The controller comprises an average current comparator and a frequency-controllable oscillator. The average current comparator is for determining if an average of the inductive current is higher than a predetermined portion of a peak current of the inductive current and generating an output signal. The frequency-controllable oscillator is for generating an operating frequency of the switch, wherein when the SMPS provides a constant output current, the output signal affects the operating frequency, the average of the inductive current approximately equals the predetermined portion of the peak current of the inductive current, and the inductive device operates in a continuous conduction mode.

The present invention further discloses a control method for a power supply with a switch and an inductive device. The control method comprises detecting an inductive current flowing though the inductive device; checking if an output current exceeds a predetermined value, using an OFF time of the switch and a representative substantially representing an average of the inductive current; and controlling an operating frequency of the switch for causing the inductive device to operate in a continuous conduction mode if the output current exceeds the predetermined value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating SMPS for converting alternating-current (AC) power source to output power source of a desired specification.

FIG. 2 is a diagram illustrating controller and feedback circuit to be used in SMPS of FIG. 1.

FIG. 3 illustrates an embodiment of average current comparator for controller in FIG. 2.

FIG. 4 illustrates an embodiment of constant current examining circuit for controller in FIG. 2.

FIG. 5 illustrates an embodiment of frequency determining circuit for controller in FIG. 2.

FIG. 6 is a diagram illustrating SMPS according to another embodiment of the present invention.

FIG. 7 illustrates controller for SMPS in FIG. 6.

### DETAILED DESCRIPTION

An embodiment of the present invention provides an SMPS for which it is unnecessary to detect the discharge time of a transformer, so as to achieve constant current functionality.

It is known by those skilled in the art that an SMPS operates in two modes: discontinuous conduction mode (DCM) and continuous conduction mode (CCM). DCM indicates that an inductive device, such as a transformer, in an SMPS is completely de-energized in every switch cycle. In other words, the inductive device in DCM has no current flowing through it for a period of time every switch cycle. On the other hand, the inductive device in CCM does not de-energize completely in one switch cycle. A critical mode or boundary mode is an operation mode approximately between DCM and CCM, indicating that the inductive device starts being energized almost right after the completion of being de-energized.

An SMPS according to an embodiment of the present invention can operate in DCM or CCM when providing a constant voltage function.

An SMPS according to another embodiment of the present invention approximately operates in CCM when providing a constant current function. Therefore, the discharge time of an inductive device, the time period during that the inductive device is de-energized to charge a load, approximately equals a turned off time of a power switch in the SMPS. Once the average current inputted to the inductive device during a turned on time of the power switch is detected, the average output current for the inductive device outputting to the load can be approximately derived. By comparing the average output current with an expected constant current, the result can be fed back to control or alter the magnitude of the average output current, thereby, achieving constant current control.

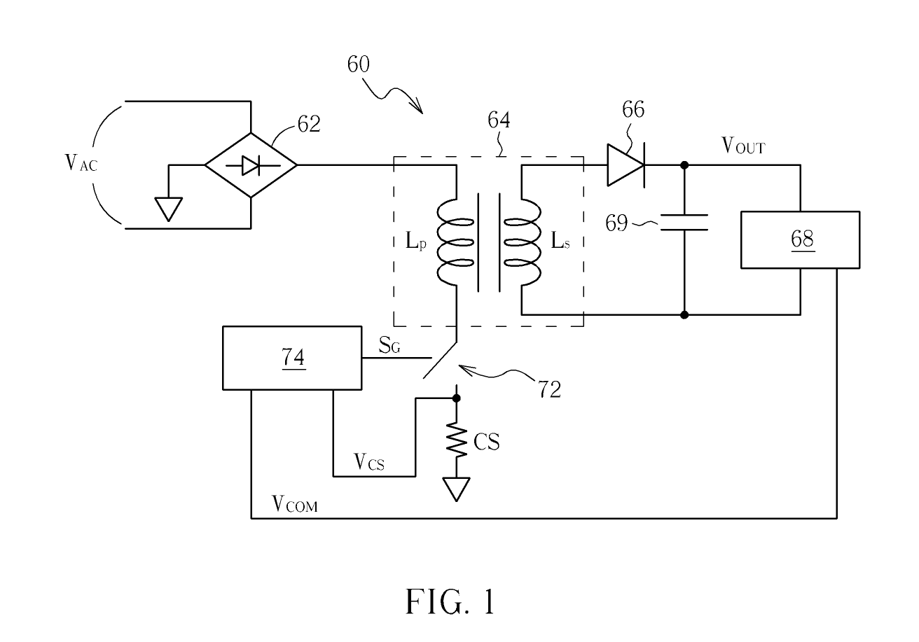

FIG. 1 is a diagram illustrating SMPS 60 for converting alternating-current (AC) power source V_{AV} to output power source V_{OUT} of a desired specification. Bridge rectifier 62 roughly rectifies AC power source V_{AC}. Power switch 72, which is controlled by gate signal S_{G}, controls current of primary coil Lₚ in transformer 64. When power switch 72 is turned on, transformer 64 is energized; when power switch 72 is turned off, transformer 64 is de-energized via secondary coil Lₛ. Through rectifier 66, the de-energized electrical energy is stored in output capacitor 69 for generating output power source V_{OUT}. Feedback circuit 68 monitors magnitude of output power source V_{OUT} (e.g. current, voltage or power) , so as to provide compensation signal V_{COM} to controller 74 accordingly. Controller 74 further receives detection signal V_{CS} generated by current sense resistor CS to switch power switch 72 periodically. According to different embodiments of the present invention, controller 74 can be an integrated circuit alone, or be integrated with power switch 72 to be an integrated circuit.

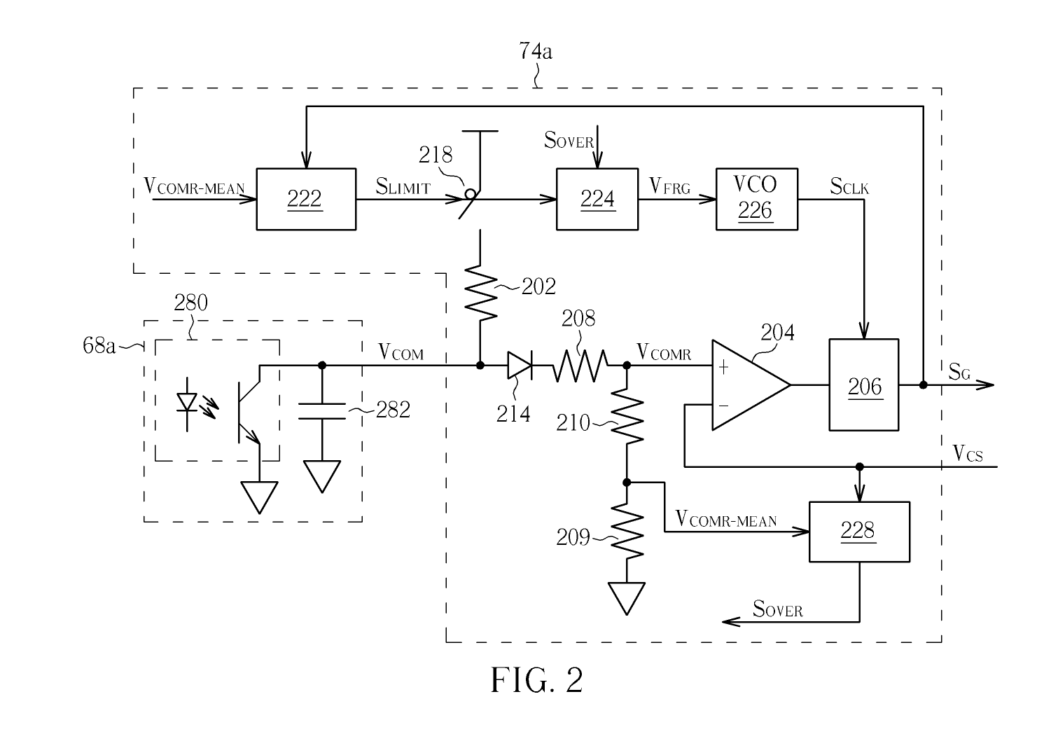

FIG. 2 is a diagram illustrating controller 74a and feedback circuit 68a to be used in SMPS 60 of FIG. 1. Feedback circuit 68a comprises photo coupler 280 and compensation capacitor 282. For instance, brightness of a light emitting diode (LED) in photo coupler 280 increases with the voltage level of output power source V_{OUT}, subsequently increasing the current drained from controller 74a and decreasing the voltage level of compensation signal V_{COM}. When switch 218 is turned on (e.g. shorted), resistor 202 and light coupler 280 in combination approximately determine the voltage level of compensation signal V_{COM} while compensation capacitor 282 keeps compensation signal V_{COM} approximately at a quasi-steady state.

In controller 74a, voltage level of compensation signal V_{COM} is stepped down by diode 214, and divided by resistors 208, 209 and 210, to generate restricted compensation signal V_{COMR}. Restricted compensation signal V_{COMR} is compared with detection signal V_{CS} by comparator 204 and the comparison result is outputted to control power switch 72 via driving circuit 206. Therefore, voltage level of restricted compensation signal V_{COMR} approximately corresponds to peak voltage of detection signal V_{CS}, which roughly determines the amount of electrical energy converted by transformer 64 in one switch cycle.

Controller 74a further comprises average current comparator 228, constant current examining circuit 222, frequency determining circuit 224 and voltage-controlled oscillator (VCO) 226. Average current comparator 228 receives detection signal V_{CS} and signal V_{COMR-MEAN}, and determines if average voltage of detection signal V_{CS} is higher than voltage level of signal V_{COMR-MEAN}, so as to output indication signal S_{OVER} accordingly. Logic “1” of indication signal S_{OVER} indicates that average voltage of detection signal V_{CS} is higher than the voltage level of signal V_{COMR-MEAN}. According to signal V_{COMR-MEAN} and clock signal S_{CLK}, constant current examining circuit 222 determines if average output current of secondary coil Lₛ in a current cycle exceeds a predetermined current value, so as to output limit signal S_{LIMIT}. When limit signal S_{LIMIT} is logic “1”, meaning average output current of secondary coil Lₛ in the current switch cycle has exceeded the predetermined current value, limit signal S_{LIMIT} of logic “1” turns off switch 218, so voltage levels of compensation signal V_{COM} and signal V_{COMR-MEAN} drop gradually, consequently decreasing average output current in following switch cycles. Frequency determining circuit 224 generates frequency voltage V_{FRG} according to limit signal S_{LIMIT} and indication signal S_{OVER}. VCO 226 determines frequency of clock signal S_{CLK} according to frequency voltage V_{FRG}.

When executing constant current function, average current comparator 228, frequency determining circuit 224 and VCO 226 as well form a negative feedback loop, causing average voltage of detection signal V_{CS} to approximately equal signal V_{COMR-MEAN}, and SMPS 60 to operate in CCM. For ensuring SMPS 60 is operating in CCM, voltage level of signal V_{COMR-MEAN} should be at least equal, or above, half of voltage level of restricted compensation signal V_{COMR}. Taking signal delay into account, resistance ratio of resistors 210 and 209 can be selected to cause signal V_{COMR-MEAN}=0.6* restricted compensation signal V_{COMR}. Average voltage of detection signal V_{CS} approximately corresponds to average current of primary coil Lₚ; restricted compensation signal V_{COMR} approximately corresponds to peak current of primary coil Lₚ. In other words, when executing constant current function, average current of primary coil Lₚ is approximately proportional to peak current of primary coil Lₚ by a predetermined ratio, which, for operating in CCM, should be approximately between 0.5 and 1, such as 0.6.

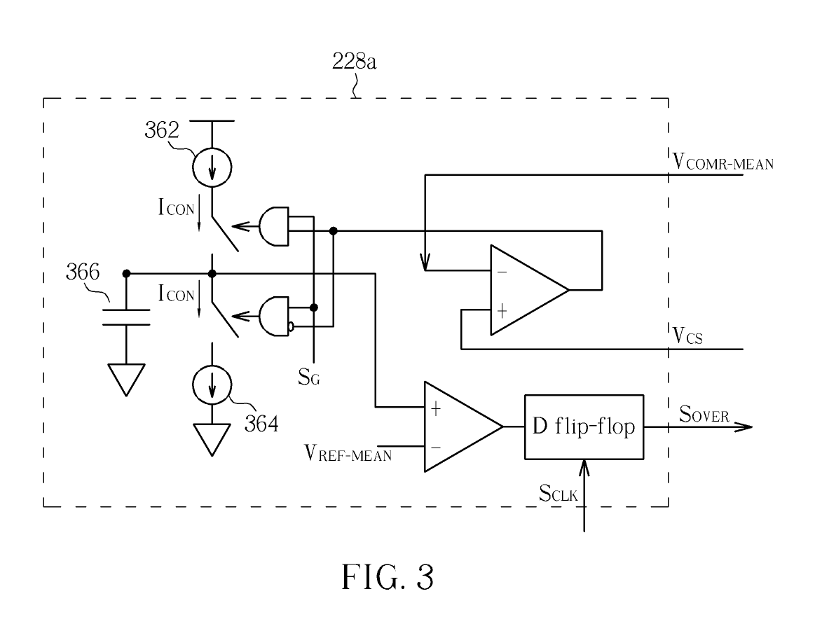

FIG. 3 illustrates an embodiment of average current comparator 228a for controller 74a in FIG. 2. Simply put, average current comparator 228a compares the duration when detection signal V_{CS} is higher than signal V_{COMR-MEAN}, with the duration when detection signal V_{CS} is lower than signal V_{COMR-MEAN}. If the former duration (i.e. the duration of when voltage level of detection signal V_{CS} is higher than that of signal V_{COMR-MEAN}) is longer, voltage level of capacitor 366 increases as the switch cycle increases; and vice versa. Therefore, if voltage level of capacitor 366 is higher than reference voltage V_{REF-MEAN} after a few switch cycles, average voltage of detection signal V_{CS} can be determined to be approximately higher than signal V_{COMR-MEAN}. Otherwise if voltage level of capacitor 366 is lower than reference voltage V_{REF-MEAN}, average voltage of detection signal V_{cs} can be determined to be lower than signal V_{COMR-MEAN}. D flip-flop causes indication signal S_{OVER} to be updated once per switch cycle, so logic level of indication signal S_{OVER} indicates if average voltage of detection signal V_{cs} is higher than signal V_{COMR-MEAN}.

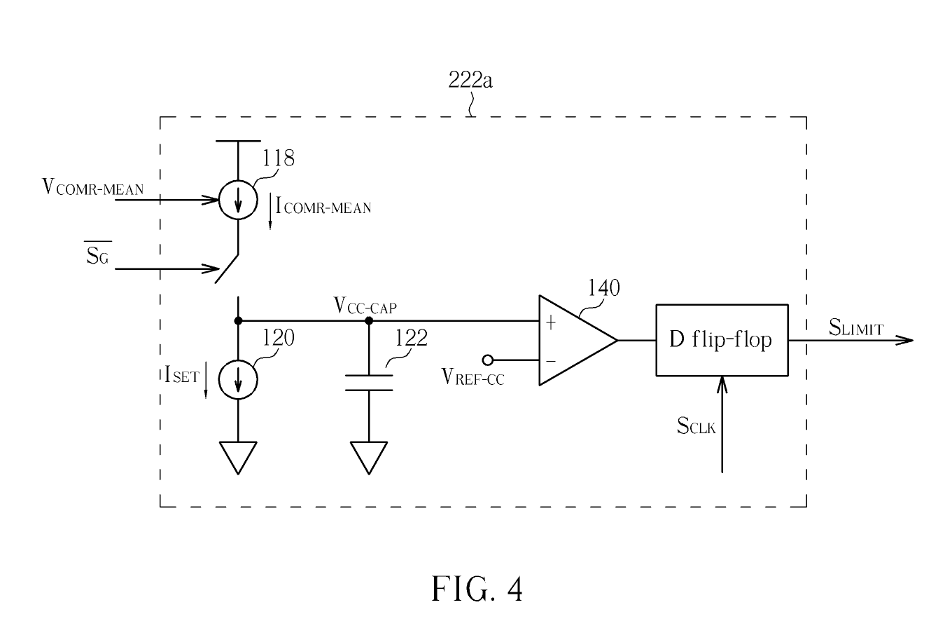

FIG. 4 illustrates an embodiment of constant current examining circuit 222a for controller 74a in FIG. 2. When operating in CCM, average output current of secondary coil Lₛ is approximately proportional to average voltage of detection signal V_{CS} when power switch 72 is turned off. As mentioned above, when executing constant current function, signal V_{COMR-MEAN} approximately represents average voltage of detection signal V_{CS}. Therefore, signal V_{COMR-MEAN} can be utilized to determine if total output electrical charge output from secondary coil Lₛ equals that of a predetermined output current. The following formula can be extrapolated from the circuit in FIG. 4:

ΔV_{CC-CAP}=I_{COMP-MEAN}*T_{OFF}I_{SET}*T_{CYCLE}

where ΔV_{CC-CAP} represents the variation of voltage V_{CC-CAP} after a switch cycle; I_{COMR-MEAN} represents current converted from signal V_{COMR-MEAN}l T_{OFF} represents the duration when power switch 72 is turned off, equivalent to the discharge time of secondary coil Lₛ; I_{SET} is a predetermined current corresponding to an expected constant output current for the load; T_{CYCLE} represents the period of a switch cycle. If voltage V_{CC-CAP} is higher than constant current reference voltage V_{REF-CC}, then the average output current of secondary coil Lₛ can be determined to be higher than the expected constant output current for the load. Accordingly, D flip-flop causes limit signal S_{LIMIT} to be logic “1”, stopping voltage level of restricted compensation signal V_{COMR} from increasing. At this moment, voltage level of restricted compensation signal V_{COMR} decreases due to discharging of light coupler 280 or resistors 208, 209.

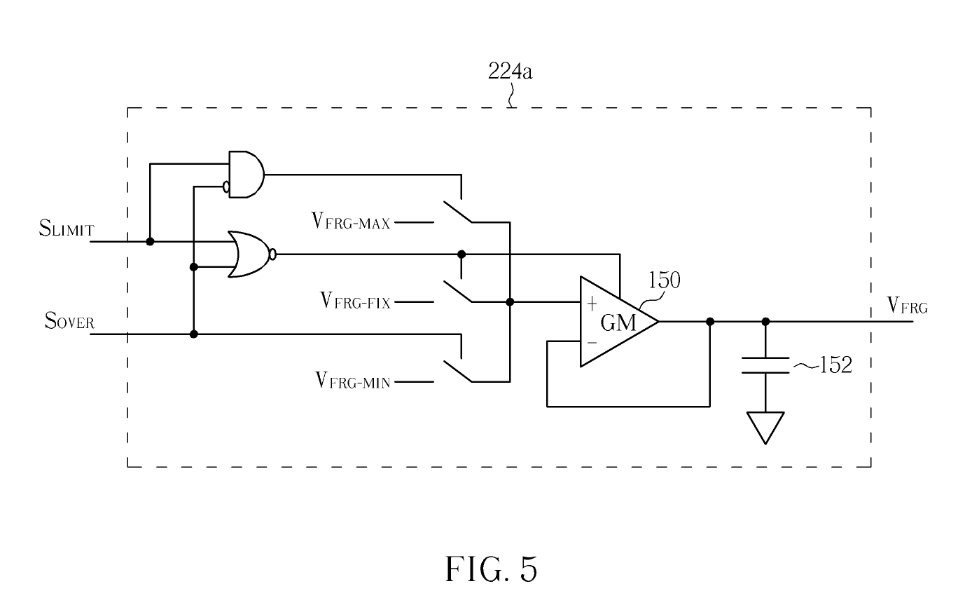

FIG. 5 illustrates an embodiment of frequency determining circuit 224a for controller 74a in FIG. 2. In frequency determining circuit 224a, when indication signal S_{OVER} is logic “1”, frequency of clock signal S_{CLK} approaches minimum frequency f_{MIN} which corresponds to minimum voltage V_{FRG-MIN}, causing average voltage of detection signal V_{CS} to drop gradually. When limit signal S_{LIMIT} is logic “0” (e.g. average output current of secondary coil Lₛ has not exceeded a predetermined value) and indication signal S_{OVER} is also logic “0”, it can be deemed that SMPS 60 is required to approach constant voltage operation, so the frequency of clock signal S_{CLK} approaches normal operating frequency f_{FIX}. When limit signal S_{LIMIT} is logic “1” (e.g. average output current of secondary coil Lₛ is assumed to have exceeded a predetermined value) and indication signal S_{OVER} is logic “0”, frequency of clock signal S_{CLK} approaches maximum frequency f_{MAX} which corresponds to maximum voltage V_{FRG-MAX}, causing average voltage of detection signal V_{CS} to increase gradually. Alternatively, it is recommended that frequency voltage V_{FRG} approaches minimum voltage V_{FRG-MIN} or maximum voltage V_{FRG-MAX} higher than it does normal operating voltage V_{FRG-FIX}, which corresponds to operating frequency f_{FIX}. For instance, assuming G_{FIX}, G_{MAX} and G_{MIN} represent transconductance gain of transconductance (GM) amplifier 150 when frequency of clock signal S_{CLK} approaches operating frequencies f_{FIX}, f_{MAX} and f_{MIN}, respectively, gain G_{FIX} is less than gains G_{MAX} and G_{MIN} in one embodiment. In FIG. 5, when frequency of clock signal S_{CLK} approaches normal operating frequency f_{FIX}, transconductance gain of GM amplifier 150 decreases accordingly.

The following scenarios can be acquired according to the logic of frequency determining circuit 224.

1. Average voltage of detection signal V_{CS} is approximately not higher than voltage level of signal V_{COMR-MEAN}, since when indication signal S_{OVER} is logic “1”, frequency of clock signal S_{CLK} drops, further decreasing average voltage of detection signal V_{CS} in the next switch cycle.
2. Limit signal S_{LIMIT} is fixed at logic “0” and SMPS 60 may approximately operate at normal operating frequency f_{FIX} when average output current of secondary coil Lₛ is continuously lower than expected constant output current for the load, such as under light load or no load.
3. Constant current function is achieved when limit signal S_{LIMIT} switches between logic “1” and “0” frequently. At this time, frequency of clock signal S_{CLK} may increase or decrease, so as to approach the frequency that makes the average voltage of detection signal V_{CS} equal to signal V_{COMR-MEAN}. Both voltage variation of compensation signal V_{COMR} and frequency variation of clock signal S_{CLK} cause subsequent limit signal S_{LIMIT} to change state, achieving constant output current.

One of the advantages of the present embodiment is elimination of detecting the discharge time of secondary coil Lₛ. If the present embodiment is applied to a low-voltage startup integrated circuit, SMPS 60 may only require 5 pins, named respectively as CS, COM, GATE, VCC and GND, for achieving constant output current and constant output voltage functions.

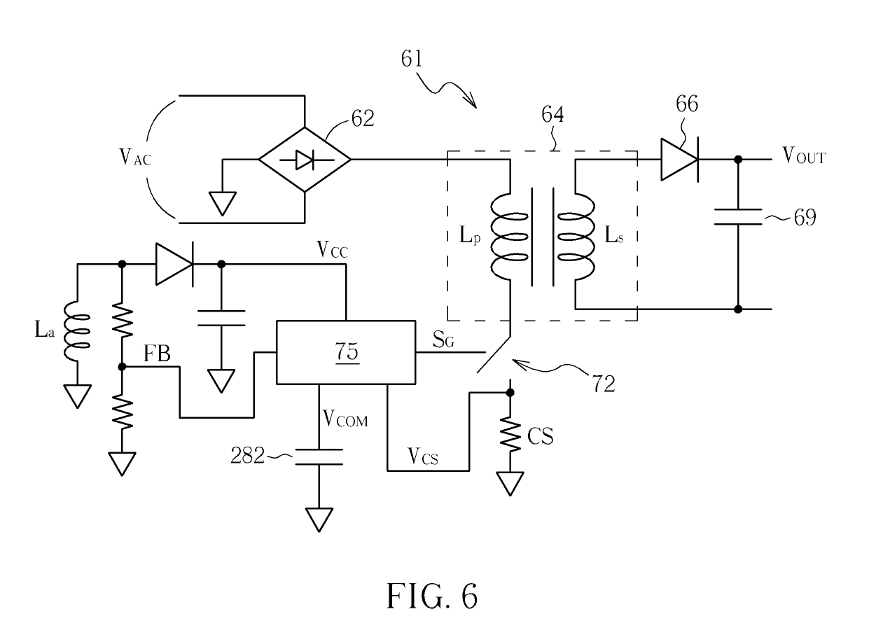

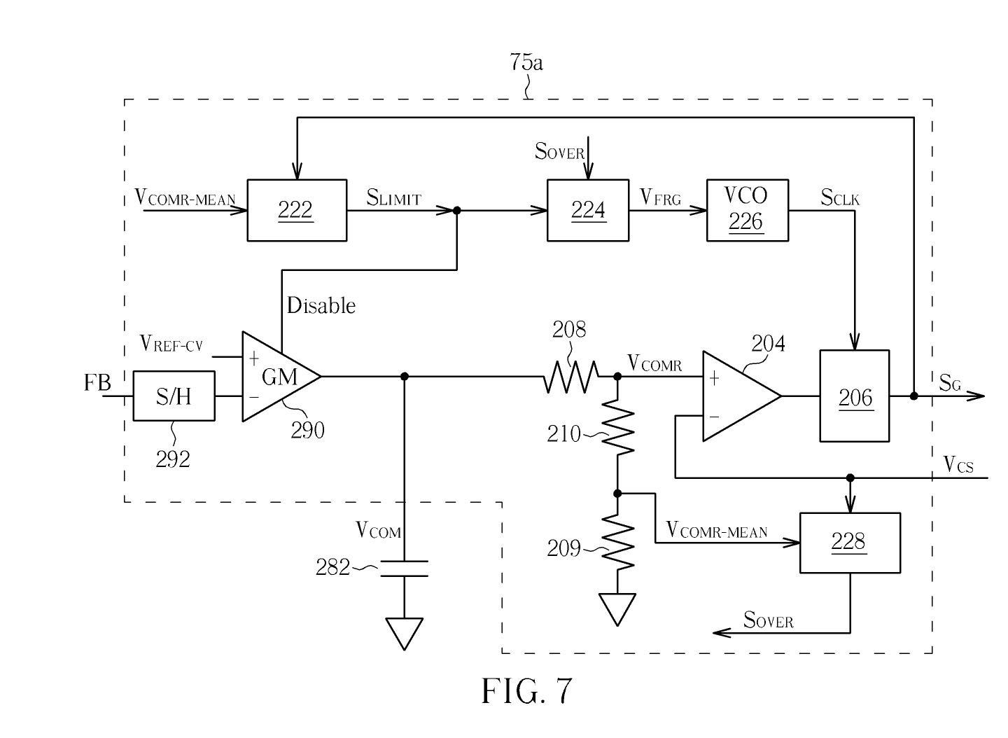

Although the above embodiment is exemplified by a secondary-side control circuit, the present invention is also applicable to a primary-side control circuit, as shown by SMPS 61 in FIG. 6. The difference between FIG. 6 and FIG. 1 is that controller 75 of SMPS 61 detects voltage of secondary coil Lₛ, which is substantially equal to the voltage of output power source V_{OUT}, via a voltage divider (e.g. consisting of two resistors) and auxiliary coil Lₐ. FIG. 7 illustrates controller 75a for SMPS 61 in FIG. 6. Sampling circuit 292 samples voltage at node FB. GM amplifier 290 compares voltage held by sampling circuit 292 with reference voltage V_{REF-CV} for generating current to charge or discharge compensation capacitor 282. When limit signal S_{LIMIT} is logic “1”, GM amplifier 290 is disabled, so voltage level of compensation signal V_{COM} decreases due to the discharge of resistors 208, 209 and 210. Other components in FIG. 6 and FIG. 7 are similar to the embodiments mentioned before, or can be extrapolated by those skilled in the art according to the above description, so relative description is omitted hereinafter. SMPS 61 in FIG. 6 can also provide constant current and constant voltage functions.

Although the invention is exemplified as applied to an SMPS having flyback architecture, it is not limited thereto, and can be applied to SMPSs having other architectures, such as buck converters, boost converters and the like.

Those skilled in the art will readily observe that numerous modifications and alterations of the device and method may be made while retaining the teachings of the invention.

What is claimed is:

1. A control method for a power supply with a switch and an inductive device, the control method comprising:
detecting an inductive current flowing though the inductive device; and
controlling an operating frequency of the switch for causing an average of the inductive current to substantially equal a predetermined portion of a peak current of the inductive current, wherein the predetermined portion approximately allows the inductive device to operate in a continuous conduction mode.

2. The control method of claim 1, further comprising:
determining if an output current of the power supply is higher than a predetermined value according to the peak current of the inductive current and a turned off time of the switch; and
stopping the peak current of the inductive current from increasing if the output current is higher than the predetermined value.

3. The control method of claim 2, further comprising:
decreasing the operating frequency when the average of the inductive current is higher than the predetermined portion of the peak current of the inductive current;
increasing the operating frequency when the output current is higher than the predetermined value and the average of the inductive current is lower than the predetermined portion of the peak current of the inductive current; and
causing the operating frequency to approach a predetermined frequency when the output current is lower than the predetermined value and the average of the inductive current is lower than the predetermined portion of the peak current of the inductive current.

4. A controller for a switched-mode power supply (SMPS), the SMPS comprising an inductive device and a switch for energizing or de-energizing the inductive device, the controller comprising:
an average current comparator, for determining if an average of the inductive current is higher than a predetermined portion of a peak current of the inductive current and generating an output signal; and
a frequency-controllable oscillator, for generating an operating frequency of the switch;
wherein when the SMPS provides a constant output current, the output signal affects the operating frequency, the average of the inductive current approximately equals the predetermined portion of the peak current of the inductive current, and the inductive device operates in a continuous conduction mode.

5. The controller of claim 4, wherein the constant current controller further comprises:
a constant current detector, for determining if the output current of the SMPS is higher than a predetermined value according to the peak current of the inductive current and a turned off time of the switch, and generating a determining signal; and
a peak current limiter for receiving the determining signal, and stopping the peak current of the inductive current from increasing when the output current is higher than the predetermined value.

6. The controller of claim 5, wherein the controller further comprises:
a frequency adjuster for controlling the operating frequency generated by the frequency-controllable oscillator according to the output signal and the determining signal.

7. The controller of claim 5, wherein the SMPS detects a voltage at a power output end, for generating a compensation signal, and the peak current limiter decreases the voltage level of the compensation signal to decrease the peak current of the inductive current.

8. The controller of claim 7, wherein the inductive device comprises a primary coil and a secondary coil, the switch controls a current of the primary coil, and the secondary coil is coupled to a power output end of the SMPS.

9. The controller of claim 8, wherein the inductive device further comprises an auxiliary coil, and the SMPS detects through the auxiliary coil the voltage at the power output end.

10. The controller of claim 6, wherein the frequency adjuster causes the operating frequency generated by the frequency-controllable oscillator to approach one of a maximum frequency, a minimum frequency and a normal frequency according to the output signal and the determining signal.

11. The controller of claim 10, wherein the operating frequency generated by the frequency-controllable oscillator approaches the maximum frequency and the minimum frequency higher than it does the normal frequency.

12. A control method for a power supply with a switch and an inductive device, the control method comprising:
detecting an inductive current flowing though the inductive device;
checking if an output current exceeds a predetermined value, using an OFF time of the switch and a representative substantially representing an average of the inductive current; and
controlling an operating frequency of the switch for causing the inductive device to operate in a continuous conduction mode if the output current exceeds the predetermined value.
